(19) United States
(12) Patent Application Publication
(10) Pub. No.: US 2020/0296401 A1
(43) Pub. Date: Sep. 17, 2020

(54) Method and Apparatus of Patch Segmentation for Video-based Point Cloud Coding

(71) Applicant: MEDIATEK INC., Hsinchu City (TW)

(72) Inventors: Ya-Hsuan LEE, Hsinchu City (TW); Jian-Liang LIN, Hsinchu City (TW)

(21) Appl. No.: 16/813,965

(22) Filed: Mar. 10, 2020

Related U.S. Application Data
(60) Provisional application No. 62/902,432, filed on Sep. 19, 2019.
(60) Provisional application No. 62/870,135, filed on Jul. 3, 2019.
(60) Provisional application No. 62/818,792, filed on Mar. 15, 2019.

(51) Int. Cl. H04N 19/46; G06T 3/40; G06T 9/00; G06T 5/00; G06T 5/20; G06T 7/50

(52) U.S. Cl. CPC H04N 19/46; G06T 3/4023; G06T 9/00; G06T 2207/20224; G06T 5/20; G06T 7/50; G06T 5/002

(57) ABSTRACT

Methods and apparatus of video coding for 3D video data are disclosed. According to one method, the gradients of the geometry frame are derived. A reconstructed point cloud is reconstructed using the geometry frame. One or more candidate holes in the reconstructed point cloud are filled based on the gradients of the geometry frame. According to another method of encoding for 3D video data, candidate hole locations in a geometry frame, patch or layer are determined. Source points projected to the candidate hole locations are grouped to generate grouped points. The grouped points are removed from an original patch containing the grouped points.

### CROSS REFERENCE TO RELATED APPLICATIONS

The present invention claims priority to U.S. Provisional Patent Application Ser. No. 62/818,792, filed on Mar. 15, 2019, U.S. Provisional Patent Application Ser. No. 62/870,135, filed on Jul. 3, 2019 and U.S. Provisional Patent Application Ser. No. 62/902,432, filed on Sep. 19, 2019. The U.S. Provisional Patent Applications are hereby incorporated by reference in their entireties.

### FIELD OF THE INVENTION

The present invention relates to coding techniques for 3D video using video-based point cloud compression. In particular, the present invention relates to improving visual quality for the video-based point cloud compression.

### BACKGROUND AND RELATED ART

The 360-degree video, also known as immersive video is an emerging technology, which can provide “feeling as sensation of present”. The contents of the immersive media scene may be represented by a point cloud, which is a set of points in a 3D space as described by its Cartesian coordinates (x, y, z) and each point is associated with corresponding attributes, such as color/texture, material properties, reflectance, normal vectors, and transparency, etc. Point clouds can be used to reconstruct or render an object or a scene as a composition of such points. Point clouds can be captured using multiple cameras and depth sensors, or artificially created. For navigation applications, light detection and ranging (Lidar) technologies are often used for 3D depth acquisition. Real-time 3D scenery detection and ranging has become an important issue for such applications.

Depending on the applications of the point clouds, the representation of point cloud data may become huge. For example, the 3D point clouds for a scene may easily exceed 100,000 points. For a moving scene at 30 frames per second, it may require hundreds of Mbps (megabits per second) to represent the 3D points with associated attributes. For high-quality applications with high resolution and/or higher frame rate, the 3D point clouds may result in multiple Gbps (gigabits per second). Therefore, point cloud compression (PCC) is important for efficient storage or transmission of point-cloud contents. Some standardization activities are being taken place under ISO/IEC JTC 1/SC 29/WG 11, Coding of Moving Pictures and Audio to develop Video-based Point Cloud Compression (V-PCC). The V-PCC is intended for category-2 point cloud data, which corresponds to time-varying point-cloud objects, such as human subjects performing different activities.

The present invention is related to patch segmentation aspect of the V-PCC to improve the performance of the V-PCC.

### BRIEF SUMMARY OF THE INVENTION

Methods and apparatus of video coding for 3D video data are disclosed. According to one method, input data related to a geometry frame associated with a point cloud are received, where the point cloud comprising a set of points in a 3D space for representing a 3D scene or a 3D object, and wherein the geometry frame corresponds to depth information of the point cloud projected onto projection planes and the geometry frame comprises one or more layers. The gradients of the geometry frame are derived. A reconstructed point cloud is reconstructed using the geometry frame. One or more candidate holes in the reconstructed point cloud are filled based on the gradients of the geometry frame.

The gradients of the geometry frame can be derived by applying a target filter to the geometry frame, where the target filter belongs to a group comprising Sobel filter, Scharr filter, Prewitt filter, Roberts filter and Laplacian filter.

In one embodiment, a target candidate hole in the reconstructed point cloud is filled if a magnitude of the gradient of the geometry frame at a corresponding current point is greater than a threshold. The target candidate hole can be determined according to a direction of the gradients of the geometry frame associated with the corresponding current point and a neighboring point. A filled point is added to a position determined according to a distance between the corresponding current point and the neighboring point, and depth value of the filled point is determined according to depth values of the corresponding current point and the neighboring point.

In one embodiment, the threshold is parsed at PPS (picture parameter set), SPS (sequence parameter set), picture header, slice header, CTU (coding tree unit), CU (coding unit), or PU (prediction unit) of a bit-stream. In another embodiment, the threshold is implicitly derived at a decoder side. In one embodiment, a flag is parsed from PPS, SPS, picture header or slice header of the bit-stream to indicate whether candidate hole filling is enabled or not in a current picture or slice.

According to another method of encoding for 3D video data, candidate hole locations in a geometry frame, patch or layer are determined. Source points projected to the candidate hole locations are grouped to generate grouped points. The grouped points are removed from an original patch containing the grouped points.

In one embodiment, said determining the candidate hole locations in the geometry frame, patch or layer comprises determining initial candidate hole locations according to various measurements. In another embodiment, said determining the candidate hole locations in the geometry frame, patch or layer further comprise counting a number of neighboring initial candidate hole locations of a target location, and the target location is determined to be one candidate hole location if the number of neighboring initial candidate hole locations of the target location is greater than a threshold.

In one embodiment, one or more limitations are imposed for said grouping the source points projected to the candidate hole locations, and wherein said one or more limitations correspond to distance from the source points to the projection plane not exceeding a threshold, the source points grouped having similar orientation, normals of the source points grouped not pointing to the projection plane, or a combination thereof.

In one embodiment, the method further comprises joining the grouped points with other patch or connected part if a condition is satisfied, and wherein the condition corresponds to the grouped points adjacent to said other patch or connected component being projected to a different projection plane, or a new projection plane being determined for the grouped points and said other patch or connected component adjacent to the grouped points being projected to the new projection plane or inverse of the new projection plane.

### BRIEF DESCRIPTION OF THE DRAWINGS

FIG. 1 illustrates an example of a point cloud frame, where an object is enclosed by a patch bounding box and each point cloud frame represents a dataset of points within a 3D volumetric space that has unique coordinates and attributes.

FIG. 2 illustrates an example of projected geometry image and texture image.

FIG. 3 illustrates an example of geometry (depth) frame having more than one layer to store the points, where two layers corresponding to near and far are used.

FIG. 4 illustrates an example of projecting 3D points onto a projection plane and generating a geometry frame having two layers.

FIG. 5 illustrates an example of reconstructing the point cloud from the geometry frame having two layers, where the reconstructed point cloud has some holes.

FIG. 6 illustrates an example of artifacts in the reconstructed point cloud, where the source point cloud is projected to a projection plane and then projected back to generate a reconstructed point cloud.

FIG. 7 illustrates an example of correlation between the gradient and possible hole locations.

FIG. 8 illustrates an example of the hole filling process.

FIG. 9 illustrates an exemplary flowchart of a coding system for point cloud compression with hole filling according to an embodiment of the present invention.

FIG. 10 illustrates an exemplary flowchart of an encoding system for point cloud compression to deal with the hole issue by separating some points from the original patch/connected component and projecting to other projection plane according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

For point cloud compression, a 3D image is decomposed into far and near components for geometry and corresponding attributes components. In addition, 2D image representing the occupancy map is created to indicate parts of the image that shall be used. The 2D projection is composed of independent patches based on geometry characteristics of the input point cloud frame. After the patches are generated, 2D frames are created to apply video encoding, where the occupancy map, geometry information, attribute information and the auxiliary information may be compressed.

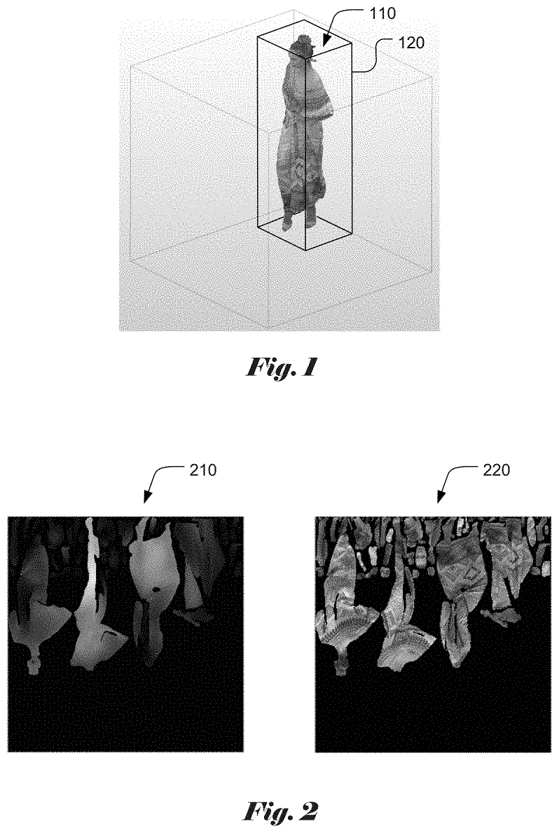

ISO/IEC MPEG (JTC 1/SC 29/WG 11) is studying the potential need for standardization of point cloud coding technology. The group is working together on this exploration activity in a collaborative effort known as the 3 Dimensional Graphics Team (3DG) to evaluate compression technology designs proposed by their experts in this area. Some ground work has been set as described in document N18190, referred as Test model Category 2 v4 (TMC2v5) algorithm description (Editor: V. Zakharchenko, V-PCC Codec Description, ISO/IEC JTC1/SC29/WG11 MPEG2019/N18190, January 2019, Marrakech). Each point cloud frame represents a dataset of points within a 3D volumetric space that has unique coordinates and attributes. An example of a point cloud frame is shown in FIG. 1, where an object 110 is enclosed by a patch bounding box 120. The object in FIG. 1 is in color originally. However, for convenience, it is shown in gray scale. A point cloud can be projected onto “bounding box” planes. The point cloud is segmented into multiple patches according to positions of the points and the normals of the points. The normal for each point is estimated based on the point and a number of its nearest neighbors. The patches are then projected and packed onto 2D images. The 2D images may correspond to geometry (i.e., depth), texture (i.e., attribute) or occupancy map. An example of projected geometry image (210) and texture image (220) is shown in FIG. 2. Furthermore, an occupancy map is also generated. The occupancy map is a binary map used to indicate each cell of the grid belonging to the empty space (e.g. a value of 0) or to the point cloud (e.g. a value of 1). Video compression can be applied to the respective image sequences.

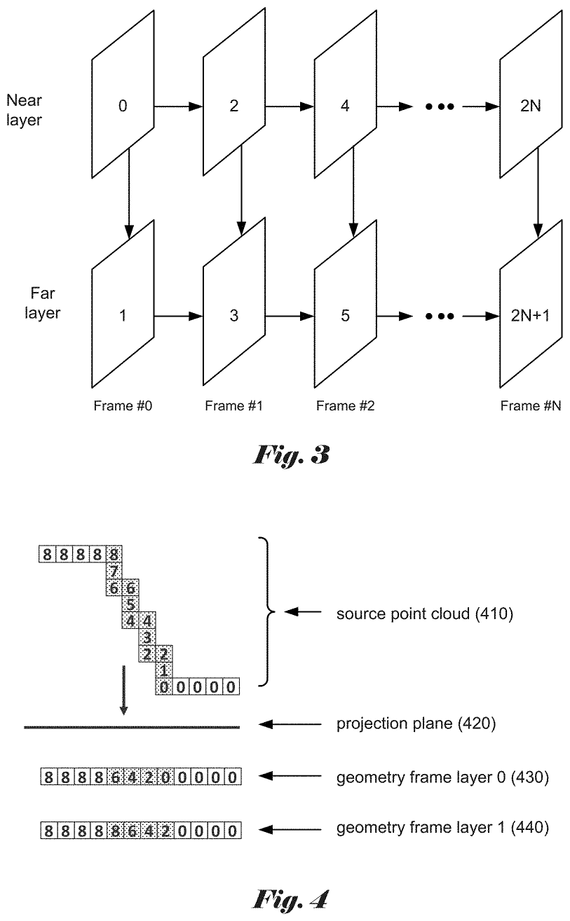

During the compression process of a point cloud, the source point cloud is divided into multiple patches and the patches are projected to projection planes. Geometry (i.e., depth) frame is then generated to store the depth information of the points. Geometry (depth) frame can have more than one layer to store the points. For example, two layers corresponding to near and far, as shown in FIG. 3, may be used. The projected points may overlap after projection since 3D-to-2D projection may cause points in 3D domain projected to the same location in the 2D projection plane. FIG. 4 illustrates an example of projecting 3D points (410) onto a projection plane (420) and generating a geometry frame having two layers (430 and 440) corresponding to near and far respectively. The number in the points indicates the depth value for each point and the points in dot-filled square indicate overlapped area. When reconstructing the point cloud from the geometry (depth) frame, holes may appear if the projection direction is not properly chosen. Since multiple points may be projected to the same location, not all points can be restored with the limited number of layers. FIG. 5 illustrates an example of reconstructing the point cloud from the geometry frame having two layers (430 and 440) in FIG. 4. As shown in FIG. 5, the reconstructed point cloud (510) has some holes (i.e., positions with missing depth) as compared to the source cloud points in FIG. 4.

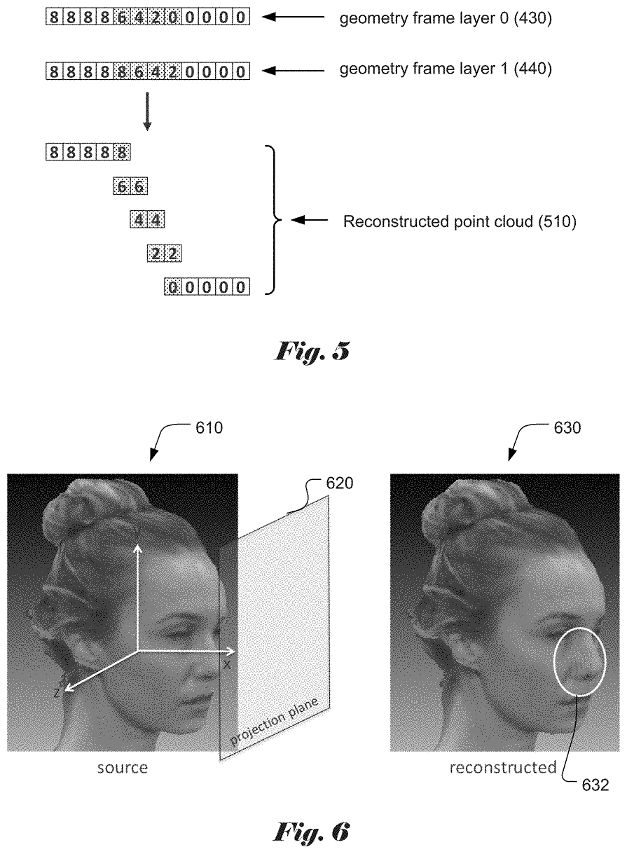

The holes in reconstructed point cloud will cause artifacts in the reconstructed 3D image. FIG. 6 illustrates an example of artifacts in the reconstructed point cloud, where the source point cloud is projected to a projection plane 620. Due to the nature of 3D-to-2D projection, not all points of the point cloud can be properly reconstructed. The reconstructed point cloud 630 illustrated the artifacts due to the holes. The artifacts are more prominent around areas with large gradient. For example, the nose area 632 as circled shows noticeable artifacts. Therefore, it is desirable to develop techniques to overcome the “hole” problem in the reconstructed point cloud.

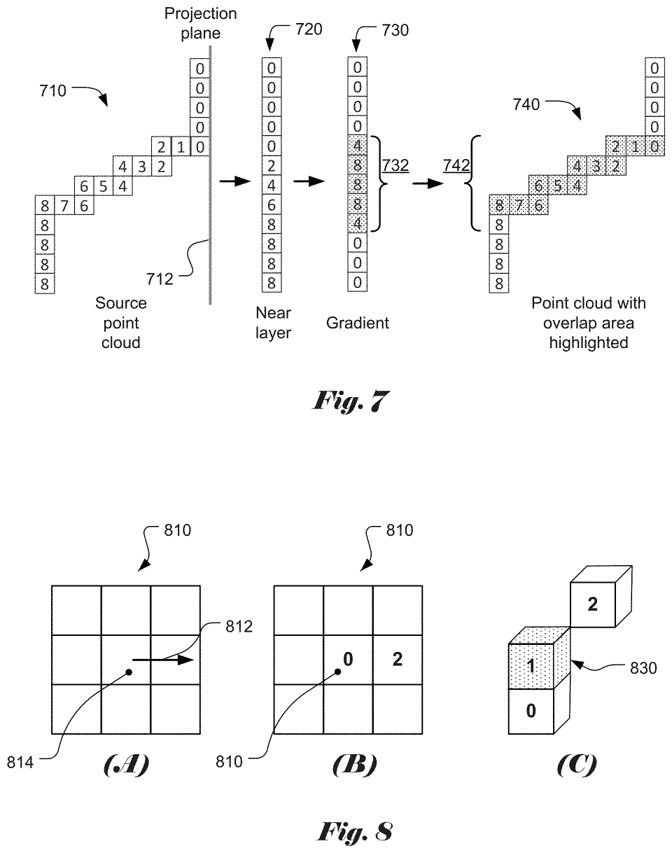

According to the observation that the holes often occur in the area with large gradients. Therefore, the gradient of the point cloud may provide clue regarding where the hole may exist. FIG. 7 illustrates an example of correlation between the gradient and possible hole locations. In FIG. 7, the source point cloud 710 is projected to a projection plane 712 to generate a near layer 720. The gradients 730 of the near layer are generated as shown. The positions with high gradient values (732) are indicated as dot-filled squares. The high gradient area is highly correlated to the potential hole area (742) in the point cloud 740 as indicated by the dot-filled positions.

To deal with the holes, methods according to the present invention will separate some points from the original patch or connected component and project to other projection plane. Exemplary process for the present invention is shown as follows

Step 1: Find the Locations That May Have Holes

Multiple methods can be used to find the candidate locations that may have holes.

Method 1: Count the number of points projected to the same location. If the number is larger than a threshold, a candidate location is declared.

Method 2: Calculate the gradient of the geometry (depth) frame, patch or any layer. If the gradient of the location is higher than a threshold, a candidate location is declared.

Various filters known in the field can be used to calculate the gradient, such as Sobel filter, Scharr filter, Prewitt filter, Roberts filter, Laplace (Laplacian) filter, etc.

Before calculating the gradient of the geometry (depth) frame, smoothing (blur) can be applied to the frame, or calculating the gradient directly without applying smoothing (blur) filter.

Method 3: Calculate the depth difference to neighboring points. If the difference is larger than a threshold, a candidate location is declared.

Step 2: Dilate the Candidate Locations

In step 1, the candidate hole locations are determined initially. These candidate hole locations can be further processed to confirm the candidate hole locations. Accordingly, the candidate hole locations determined in step 1 are also referred as initial candidate hole locations.

In step 2, for each pixel, count the number of neighboring candidate locations. If the number is larger than a threshold, the current location is then regarded as a candidate location. Alternatively, if the number of points projected onto the current location, the gradient of the current location, or depth difference on the current location is larger than a threshold, the current location is regarded as a candidate location.

This step may be iteratively executed.

Step 3: Group Points Projected to the Candidate Locations

The step 1 and step 2 could be performed for both encoder and decoder. However, step 3 and the remaining steps are intended for the encoder since it requires to access the source point cloud. In step 3, adjacent points projected to the candidate locations are grouped. Some limitations may be applied for choosing points to be grouped.

Limitation 1: The point should be close to the projection plane. In other words, only points that are close to each other can be grouped. For example, the distance to the projection plane cannot exceed a threshold.

Limitation 2: Points in the same group should have similar orientation. The orientation can be determined by the normal.

Limitation 3: Normals of points should not point to the projection plane

Step 4: Remove the Grouped Points from the Original Patch or Connected Component

Groups containing less points (e.g., the number of points in the group smaller than a threshold) will not be removed.

The removed groups may join other patch or connected component that has different projection direction (orientation), or become a new patch or connected component.

Step 5: Test if the Removed Groups can Join Other Patch or Connected Component that is Projected to a Different Projection Plane

There are two alternative methods that can be used to perform the test.

Method 1: If the group is adjacent to other patch/connected component that is projected to a different projection plane, then it can join that patch/connected component.

Method 2: Calculate a new projection plane/orientation for each removed group. If the group is adjacent to other patch/connected component that is projected to the same new projection plane or the inverse projection plane, then the removed group can join that patch/connected component.

Step 6: Form New Patches/Connected Components for Groups that Do Not Join Other Patch/Connected Component

In this step, a new projection plane/orientation for each remaining group is calculated. Various methods are disclosed for calculating a new projection plane/orientation for the new generated patch/connected component as follows.

Method 1: Use the original orientation (i.e., the orientation before refinement) as the new one.

Method 2: Calculate the sum of the normals in the patch/connected component. Determine the projection plane/orientation according to the values of the sum.

Method 3: Project the points to different projection planes, and choose the one that can store the most number of points.

Method 4: The bounding box of the patch/connected component is calculated first, and the shortest boundary, either excluding or including the boundary along the previous orientation, is regarded as its projection line. To determine the direction, or the max or min depth values to be stored, the connected component is projected along the positive direction and the negative direction of the projection line to one or more layers. By counting the number of reconstructed points from the layers for each direction (i.e., the positive or the negative directions), the one with more points will be chosen as the new projection plane/orientation.

As mentioned earlier, step 1 and step 2 are applicable to both encoder and decoder for hole filling. In particular, the gradient-based method to identify the candidate hole locations is useful for hole filling. In order to find the possible holes, the gradients of the geometry (i.e., depth) frame can be calculated. As mentioned before, various filters known in the field can be used to calculate the gradient, such as Sobel filter, Scharr filter, Prewitt filter, Roberts filter, Laplace (Laplacian) filter, etc. Prior to calculating the gradient of the geometry (depth) frame, smoothing (blur) can be applied on the frame.

The gradient magnitude can be used to indicate the region that may have holes. For example, a threshold can be defined. If the gradient magnitude is larger than the threshold, the hole filling method should be applied to this location. The gradient direction indicates the direction of the slope to add points for filling the hole. According to the gradient magnitude and direction, the region and direction to apply the hole filling method can be found in the 2D domain, which can reduce complexity compared to finding the holes in the 3D domain.

With the depth information stored in the geometry (depth) frame, points can be added to the holes in the reconstructed point cloud. According to the gradient direction, the current pixel can find a neighboring pixel along this direction. Points can then be added at the positions calculated according to the distance and the depth value of the current pixel and that neighboring pixel. FIG. 8 illustrates an example of the hole filling process. In FIG. 8A, the gradient direction 812 at a current pixel location 814 for a region 810 is shown, where gradient direction 812 at the current pixel location points to its right neighboring pixel. The distance between the current pixel and its neighboring pixel on the right in the geometry (i.e., depth) frame is 1, and the difference of their depth values is 2 as shown in FIG. 8B. A point 830 is then added at the location according to the distance and the depth value as shown in FIG. 8C.

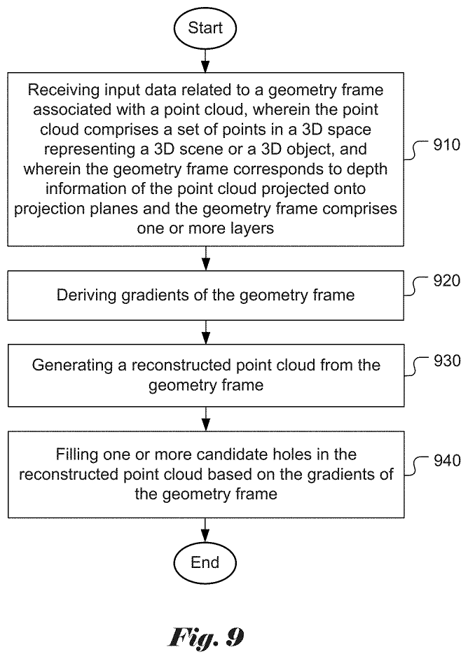

FIG. 9 illustrates an exemplary flowchart of a coding system for point cloud compression with hole filling according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data related to a geometry frame associated with a point cloud are received in step 910, wherein the point cloud comprises a set of points in a 3D space representing a 3D scene or a 3D object, and wherein the geometry frame corresponds to depth information of the point cloud projected onto projection planes and the geometry frame comprises one or more layers. Gradients of the geometry frame are derived in step 920. A reconstructed point cloud is generated from the geometry frame in step 930. One or more candidate holes in the reconstructed point cloud are filled based on the gradients of the geometry frame in step 940.

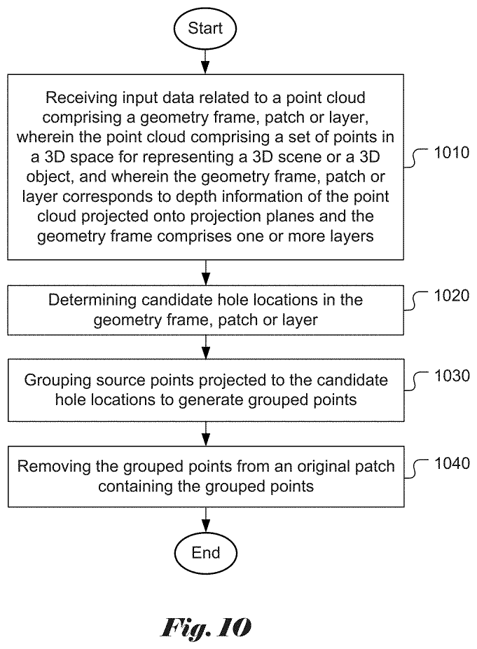

FIG. 10 illustrates an exemplary flowchart of an encoding system for point cloud compression to deal with the hole issue by separating some points from the original patch/connected component and projecting to other projection plane according to an embodiment of the present invention. According to this method, input data related to a point cloud comprising a geometry frame, patch or layer are received in step 1010, wherein the point cloud comprising a set of points in a 3D space for representing a 3D scene or a 3D object, and wherein the geometry frame, patch or layer corresponds to depth information of the point cloud projected onto projection planes and the geometry frame comprises one or more layers. Candidate hole locations in the geometry frame, patch or layer are determined in step 1020. Source points projected to the candidate hole locations are grouped to generate grouped points in step 1030. The grouped points are removed from an original patch containing the grouped points in step 1040.

The flowcharts shown above are intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding for 3D video data, the method comprising:
receiving input data related to a geometry frame associated with a point cloud, wherein the point cloud comprises a set of points in a 3D space representing a 3D scene or a 3D object, and wherein the geometry frame corresponds to depth information of the point cloud projected onto projection planes and the geometry frame comprises one or more layers;
deriving gradients of the geometry frame;
generating a reconstructed point cloud from the geometry frame; and
filling one or more candidate holes in the reconstructed point cloud based on the gradients of the geometry frame.

2. The method of claim 1, wherein the gradients of the geometry frame are derived by applying a target filter to the geometry frame, and wherein the target filter belongs to a group comprising Sobel filter, Scharr filter, Prewitt filter, Roberts filter and Laplacian filter.

3. The method of claim 1, wherein a target candidate hole in the reconstructed point cloud is filled if a magnitude of the gradient of the geometry frame at a corresponding current point is greater than a threshold.

4. The method of claim 3, wherein the target candidate hole is determined according to a direction of the gradients of the geometry frame associated with the corresponding current point and a neighboring point.

5. The method of claim 4, wherein a filled point is added to a position determined according to a distance between the corresponding current point and the neighboring point, and wherein depth value of the filled point is determined according to depth values of the corresponding current point and the neighboring point.

6. The method of claim 3, wherein the threshold is parsed at PPS (picture parameter set), SPS (sequence parameter set), picture header, slice header, CTU (coding tree unit), CU (coding unit), or PU (prediction unit) of a bit-stream or the threshold is implicitly derived at a decoder side.

7. The method of claim 1, wherein a flag is parsed from PPS (picture parameter set), SPS (sequence parameter set), picture header or slice header of a bit-stream to indicate whether said filling said one or more candidate holes in the reconstructed point cloud is enabled or not in a current picture or slice.

8. An apparatus of video coding for 3D video data, the apparatus comprising one or more electronic circuits or processors arranged to:
receive input data related to a geometry frame associated with a point cloud, wherein the point cloud comprises a set of points in a 3D space representing a 3D scene or a 3D object, and wherein the geometry frame corresponds to depth information of the point cloud projected onto projection planes and the geometry frame comprises one or more layers;
derive gradients of the geometry frame;
generate a reconstructed point cloud from the geometry frame; and
fill one or more candidate holes in the reconstructed point cloud based on the gradients of the geometry frame.

9. A method of video encoding for 3D video data, the method comprising:
receiving input data related to a point cloud comprising a geometry frame, patch or layer, wherein the point cloud comprising a set of points in a 3D space for representing a 3D scene or a 3D object, and wherein the geometry frame, patch or layer corresponds to depth information of the point cloud projected onto projection planes and the geometry frame comprises one or more layers;
determining candidate hole locations in the geometry frame, patch or layer;
grouping source points projected to the candidate hole locations to generate grouped points; and
removing the grouped points from an original patch containing the grouped points.

10. The method of claim 9, wherein said determining the candidate hole locations in the geometry frame, patch or layer comprises determining initial candidate hole locations according to a measurement.

11. The method of claim 10, wherein the measurement corresponds to counting a number of source points projected to a same location of the geometry frame, patch or layer, and wherein if the number of source points projected to the same location of the geometry frame, patch or layer is larger than a threshold, the same location of the geometry frame, patch or layer is determined as one of the initial candidate hole locations.

12. The method of claim 10, wherein the measurement corresponds to calculating gradient of the geometry frame, patch, or layer at a target location, and wherein if the gradient of the geometry frame, patch, or layer at the target location is higher than a threshold, the target location is determined as one of the initial candidate hole locations.

13. The method of claim 12, wherein the gradient of the geometry frame, patch, or layer at the target location is derived by applying a target filter to the geometry frame, patch, or layer at the target location, and wherein the target filter belongs to a group comprising Sobel filter, Scharr filter, Prewitt filter, Roberts filter and Laplacian filter.

14. The method of claim 13, wherein a smoothing filter is applied to the geometry frame, patch, or layer prior to said calculating the gradient of the geometry frame, patch, or layer at the target location.

15. The method of claim 10, wherein the measurement corresponds to depth differences between a target location of the geometry frame, patch or layer to neighboring points, and if at least one of the depth differences is larger than a threshold, the target location of the geometry frame, patch or layer is determined as one of the initial candidate hole locations.

16. The method of claim 10, wherein said determining the candidate hole locations in the geometry frame, patch or layer further comprise counting a number of neighboring initial candidate hole locations of a target location, and the target location is determined to be one candidate hole location if the number of neighboring initial candidate hole locations of the target location is greater than a threshold.

17. The method of claim 9, wherein one or more limitations are imposed for said grouping the source points projected to the candidate hole locations, and wherein said one or more limitations correspond to distance from the source points to the projection plane not exceeding a threshold, the source points grouped having a similar orientation, normals of the source points grouped not pointing to the projection plane, or a combination thereof.

18. The method of claim 9 further comprises joining the grouped points with other patch or connected part if a condition is satisfied, and wherein the condition corresponds to the grouped points adjacent to said other patch or connected component being projected to a different projection plane, or a new projection plane being determined for the grouped points and said other patch or connected component adjacent to the grouped points being projected to the new projection plane or inverse of the new projection plane.

19. The method of claim 18 further comprising forming a new patch or connected component for the grouped points if the grouped points do not join any other patch or connected component.

20. The method of claim 19, wherein said forming the new patch or connected component for the grouped points comprises calculating the new projection plane, a new orientation or both for the grouped points.

21. The method of claim 20, wherein the new projection plane and the new orientation are determined according to a sum of normals of the grouped points.

22. The method of claim 20, wherein the new projection plane is determined as one of candidate projection planes that results in a maximum number of points stored for the grouped points.

23. An apparatus of video encoding for 3D video data, the apparatus comprising one or more electronic circuits or processors arranged to:
receive input data related to a point cloud comprising a geometry frame, patch or layer, wherein the point cloud comprising a set of points in a 3D space for representing a 3D scene or a 3D object, and wherein the geometry frame, patch or layer corresponds to depth information of the point cloud projected onto projection planes and the geometry frame comprises one or more layers;
determine candidate hole locations in the geometry frame, patch or layer;
group source points projected to the candidate hole locations to generate grouped points; and
remove the grouped points from an original patch containing the grouped points.
